(19) United States
(12) Patent Application Publication
(10) Pub. No.: US 2005/0177387 A1
(43) Pub. Date: Aug. 11, 2005

(54) Method and Process of Procurement of Information about Items and the Population of Personal Inventory or (Global) Consignment Node Databases and Associated Item Search Capabilities

(76) Inventor: Tomasz Mariusz Mojsa, San Jose, CA (US)

Correspondence Address: Tomasz Mariusz Mojsa, PO Box 4508, Foster City, CA, 94404, US

(21) Appl. No.: 10/906,060

(22) Filed: Feb. 1, 2005

Related U.S. Application Data
(60) Provisional application No. 60/481,990, filed on Feb. 2, 2004.

(51) Int. Cl. G06F 17/60

(52) U.S. Cl. 705/1

(57) ABSTRACT

A method and apparatus for automated procurement of information about electronic items such that the information is to be used in the population of consignment or personal inventory node database entries in a network of consignment nodes or personal inventory nodes for used and collectible electronic goods having inherent electronic networking capability using arbitrary set of protocol stacks/protocols. The invention describes a novel and unexpected use of a plurality of low cost posting/search/access terminals (laptops, PCs, PDAs, SUN computers etc) that had been so far used as manual entry stations serving the purpose of manual population of the said consignment node or personal social networking profiles by humans. The novelty of the invention describes the unexpected use of such terminals as themselves being the subject and source of automatically gleaned information suitable for the population of global consignment or personal inventory node databases. The present invention additionally claims the method and process of searching for and search methods used to find tangible electronic assets.

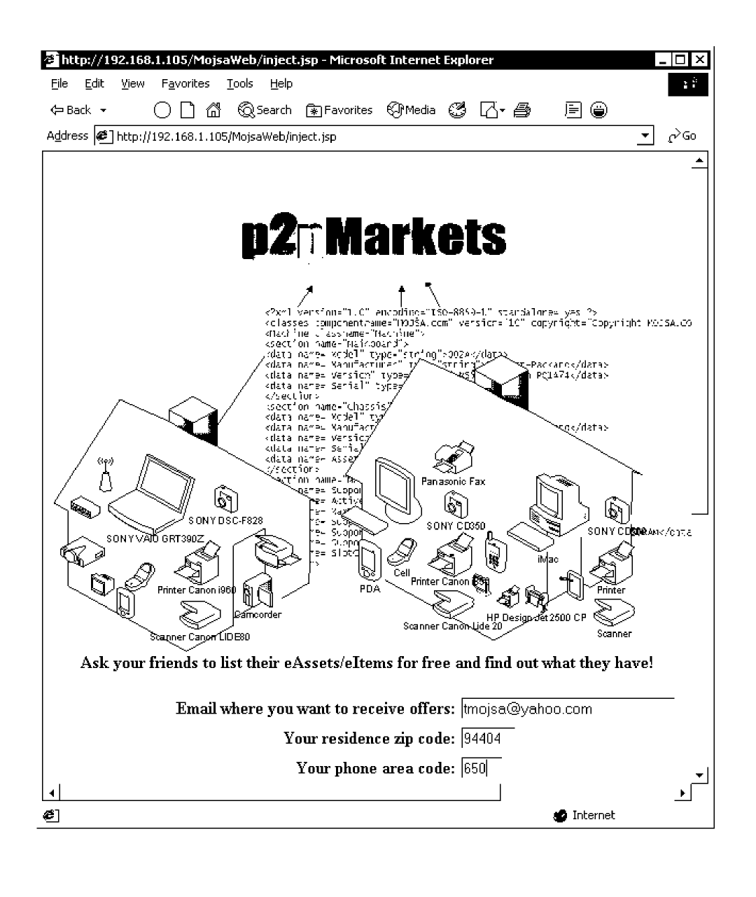

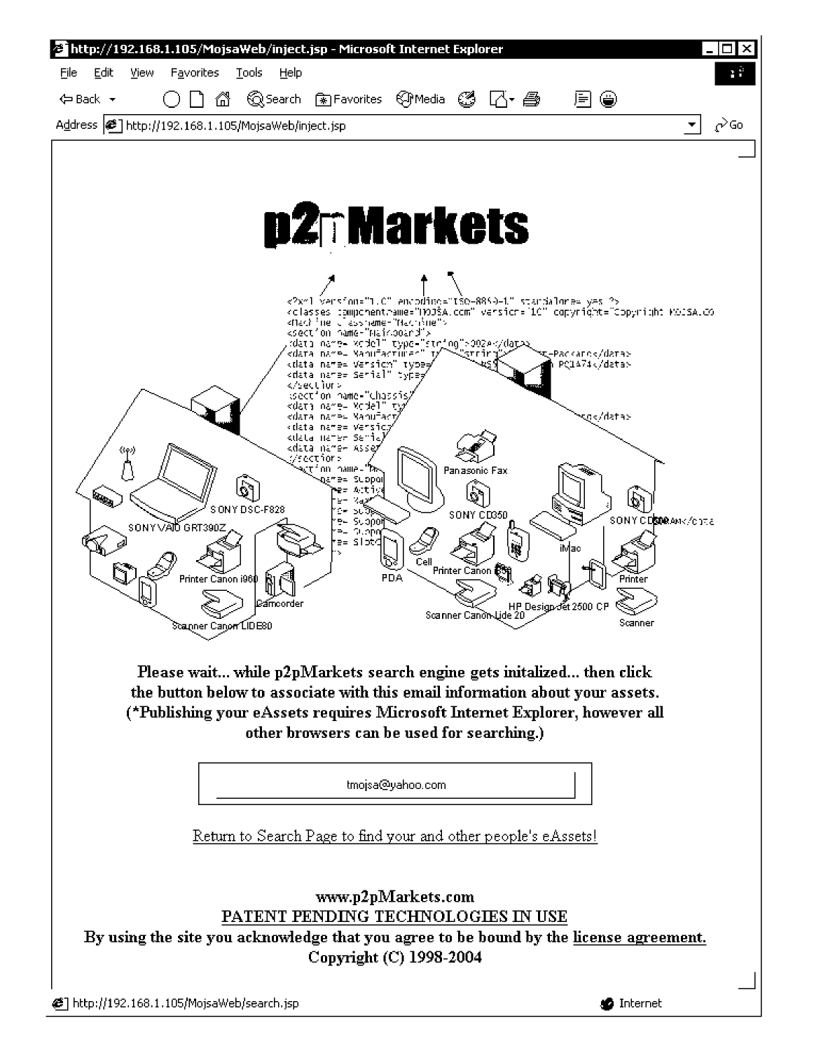

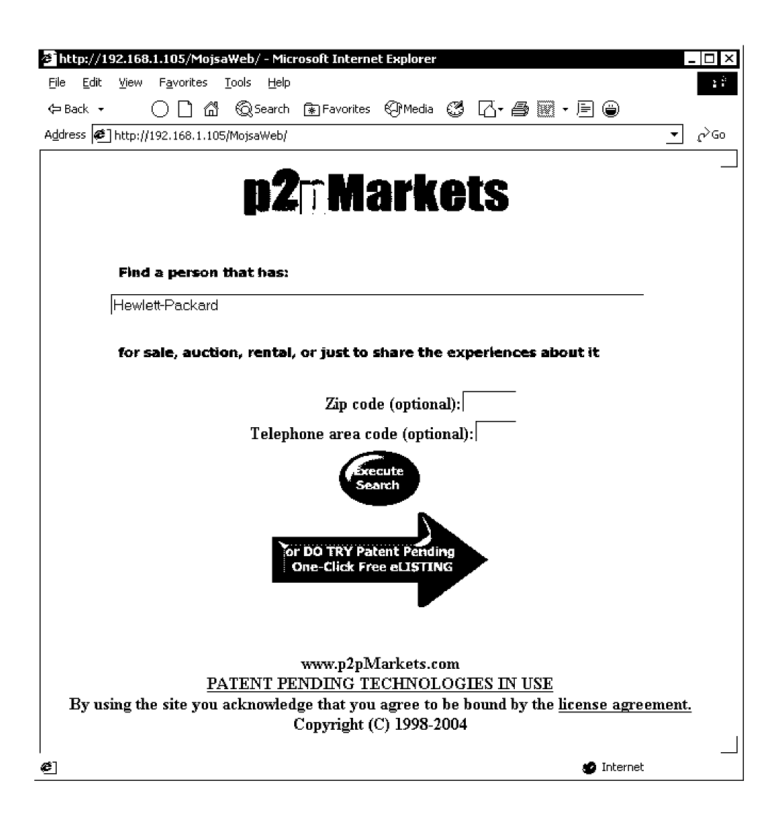

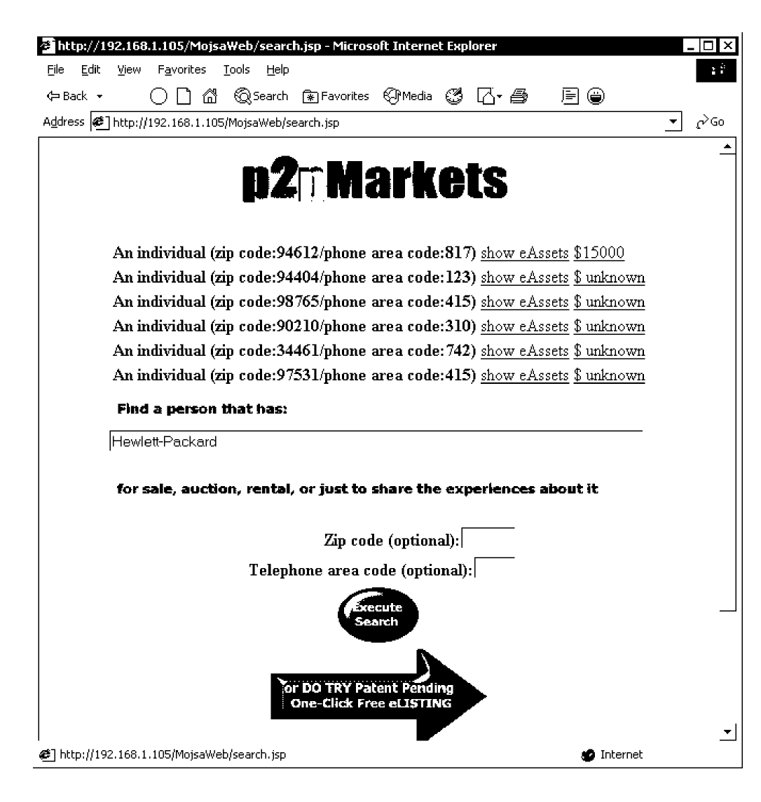

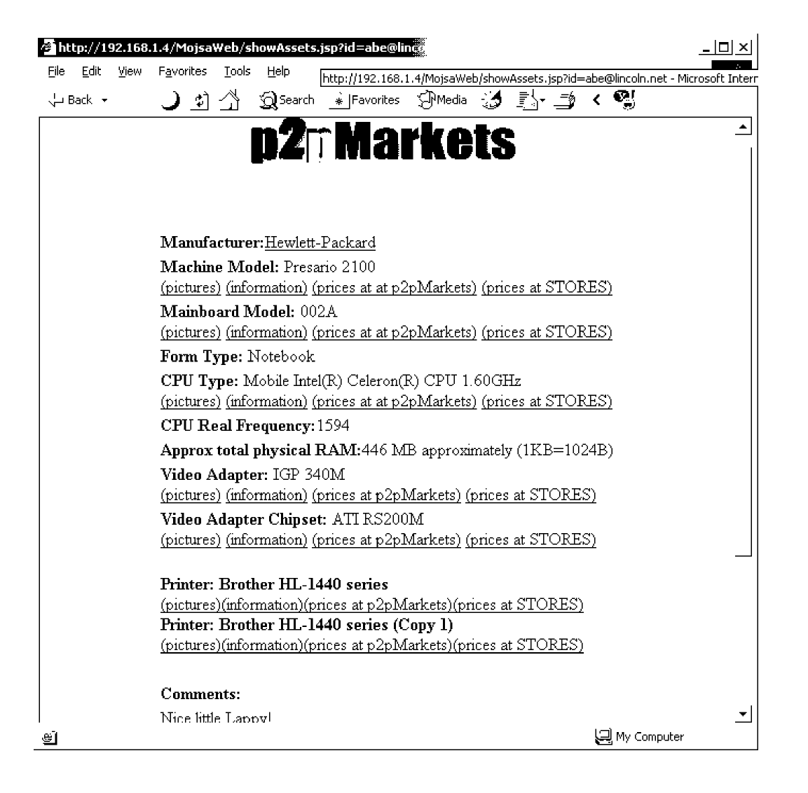

This application claims the benefit of U.S. Provisional Application No. 60/481,990 filed Feb. 02, 2004 with EFS ID 54584 by Tomasz Mariusz Mojsa confirmation No. 1990.

### BACKGROUND OF INVENTION

The present invention describes a new process and method of procurement of information about items such that the information can be used in the population of Consignment Nodes and their associated Databases such as those disclosed in a U.S. Pat. No. 5,845,265, U.S. Pat. No. 6,085,176, U.S. Pat. No. 6,202,051, U.S. Pat. No. 6,266,651. The present invention describes a new process and method of procurement of information about items such that the information can used in the population of a new form of electronic items virtual Personal Inventory Nodes/Databases introduced by the invention. Personal Inventory Database differs from Consignment Node Database in being user specific (Tom's electronic inventory database) rather than site specific (Auction House Database). Personal Inventory Nodes/Databases may be associated with each user profile in a social networking database. Social networking databases (a different concept from Consignment Node Database or Personal Inventory Node/Database) themselves, might be created using the invention disclosed in U.S. Pat. No. 6,175,831 but not necessarily. In general, the present invention addresses the creation and population of Personal Inventory Nodes/Databases in any networked community of profiles created in any way such that user profiles additionally contain information about items being in the physical vicinity/accessibility of users. The information about items is amassed in the Personal Inventory database and is perpendicular to any social networking databases that store user profiles. The process and method of procurement of information used in the population of the Personal Inventory Node databases (describing what is in the vicinity of a user) and being coupled to the user profile and most specifically the creation and updates of such databases is described and stipulated as the subject of this invention. The databases created, populated or updated shall be called Personal Inventory Node Databases. The current invention also uses the same method and process in the populating of Consignment Node databases disclosed in the above quoted Woolston patents in addition to the mentioned above Personal Inventory Node Databases that are coupled to each profile in a social networking database of profiles.

Certain items and used goods do have a significant following in a society of hobbyists, collectors or just regular individuals using them on a daily basis. Those items include baseball cards, pens, books, dolls, laptops, printers, digital cameras, camcorders, MP3 players, DVDs, CDs with music, cars etc. Electronically accessible ones, while often being more like commodities can are also be the subject of extensive market demand. In the case of electronically accessible items this might be due to their store unavailability resulting from manufacturer's cease of production and replacement with a new more expensive model or simply insufficient production yet at the given stage (for example a new model SONY camera may not be in the hands of many yet just like the newest DVD with some newest movie). Also older items might be of great interest to a number of people as they are in most cases fully functional and usable—for example an older model SONY CD1000 digital camera that still delivers supreme quality pictures. Prior art related to listing such items in all sorts of auction databases (Consignment Node Databases) does not differentiate between such electronic items and non-electronic items and does not exploit the benefits that most modern items with electronic circuits and some form of networking capabilities (USB 1.x, 2.x, 802.11x, PCI Bus, ISA Bus, SCSI etc) posses in manifesting their presence as a side-effect of the main utilitarian use. The invention describes a method and process of procurement of information about the whereabouts of those items and their association with a particular user (them being in the vicinity, possession or maybe access of a particular human being) as well as their injection into (Global) Consignment Node or Personal Inventory Node Databases by directly or indirectly, implicitly or explicitly leveraging those features of electronic goods.

The present invention may relate to the population of consignment node databases as described in U.S. Pat. No. 5,845,265, U.S. Pat. No. 6,085,176, U.S. Pat. No. 6,202,051, U.S. Pat. No. 6,266,651 that allow sellers and buyers accessing described therein consignment node(s)to remotely search and populate their databases using search or posting terminals respectively. The present invention refers to such nodes a (Global) Consignment Nodes. A Global Consignment Node is such a node type groups by categories and emphasizes and allows users to search for items. Such Global Consignment Nodes group physical possessions by categories in (Global) Consignment Node Database. Of course the act of merely load-balancing/fail-over distribution of such a node shall still classify it as a Global Consignment Node.

The current invention additionally mentions a Personal Inventory Node with its Database. It might be also called Personal Consignment Node that might be a part of a personal user profile of a given individual in a social networking database. Such a node groups all items possessed by a given individual whose profile is in here discussed. A simple list of items one possesses can be construed as the simplest form of such a Personal Consignment Node/Database and the Profile itself might be a part of a perpendicular social networking database. The invention describes the method and process of populating the Personal Inventory Node/Personal Inventory Databases. For example sites like eBay.com may be considered to be an example of a (Global) Consignment Node or just Consignment Node that falls more into the category of inventions described in U.S. Pat. No. 5,845,265, U.S. Pat. No. 6,085,176, U.S. Pat. No. 6,202,051, U.S. Pat. No. 6,266,651. The current invention additionally discusses Personal Inventory/Consignment Nodes that differ from a (Global) Consignment Nodes in the former being contained or closely coupled to the profiles of users interconnected by software social networking relationship links created. (Global) Consignment Nodes focus on amassing items for sale/auctioning purposes and partitioning the goods by item types and categories, topical subjects such as cameras, VCRs, hard drives, cars. Personal Consignment/inventory Nodes group information about items owned/within the proximity of a given individual such as Tom's items that include a SONY camera CD350 and an Averatec 3150P laptop, Tom's RIO MP3 Player etc. Items listed in a network of Personal Consignment Node databases can be projected onto/grouped by item categories existing in Global Consignment Node Databases (Category CAMERAS: Tom's SONY CD350, John's SONY CD500, Peter's SONY CD400). Items listed in categories of a (Global) Consignment Node database can be projected/split-projected onto Personal Node Databases (each item in a category has its owner and the items can be apportioned to each owner's Personal Inventory/Consignment Database). The current invention associates a total electronically accessible Personal Inventory in the possession or vicinity of a given individual with his/her email that is possibly associated with a Profile in a social networking arrangement but first and foremost describes a method and process of procurement of information used in the population of node databases, be it Personal Inventory Nodes' or Global Consignment Nodes' Databases. As seen in the above the Personal Inventory Node databases in some implementations might in fact be purely virtual as a Profile listed as part of some other database might be a Personal Inventory Node containing the database.

The present invention describes a novel, unexpected and not encountered in prior art method and process of automatic procurement of information about the existence or possession in the hands of posting/search terminal users (of Global Consignment or Personal Inventory Nodes) of certain items and the technical characteristics of such items. Such information is used in the population of the said Global Consignment or Personal Inventory Node databases thus representing a novel, unexpected and surprising use of posting/search/computer terminals for the detection and discovery of existence and the characteristics of electronic items in their proximity. This includes the electronic artifacts directly forming the posting terminals/computers such as graphics cards, memory, hard disks and entire terminals such as for example laptops themselves and devices such as cameras, camcorders, displays, and even BlueTooth enabled cars that may come into transient vicinity of the laptops acting as posting terminals in respect to the Global Consignment Node/Personal Inventory Node Databases.

The present invention claims and describes a novel, unexpected and unusual way of procurement of information suitable for the injection into/population of such personal or global consignment/inventory node databases containing data on used or new, collectible or commodity items for sale or auction sale purposes. The novel invention relies on and claims an unusual, unexpected and non-obvious use of posting terminals that had been so far in prior art the source of human entered information by means of Graphical User Interface driven tools that were used to create/author records describing items for sale or auctioning purposes by humans inputting information on items. The current invention minimizes or even obliterates the need for human and manual gathering and authoring of the information injectable into the various types of consignment node-like, non-consignment node-like/personal inventory node-like or non-consignment node-like databases and provides for enormous proliferation of very accurate entries about tangible items.

Most modern electronic items have inherent capability of automated manifestation of their presence on different types of networks such as Ethernet, 802.11, 802.11a/b/g/x, BlueTooth, USB 1.1 /2.0 etc., WLAN, FireWire, PCI Bus etc. This networking feature, often used for satisfying other significant utilitarian aspects of their purpose (transfer of data to print, upload pictures, access speeds etc.), can be exploited in the detection and inference, be it implicit or explicit, of their physical presence at a point in time, technical characteristics and brand name as well as technical capabilities and parameters via their networked proximity to the posting terminal. Simple piece of software downloadable to the posting terminals can thus glean information about electronic items in the proximity of the posting terminal, including the posting terminal itself and its constituent components, by leveraging the said networking capability of said electronic items connected to the said posting terminal. The posting terminal, as described in U.S. Pat. No. 5,845,265, U.S. Pat. No. 6,085,176, U.S. Pat. No. 6,202,051, U.S. Pat. No. 6,266,651, or seen in prior art of auction web sites, serves the purpose of human driven population of consignment nodes with entries as well as performing searches for those entries. The novel and non-obvious use and claim of the current invention and its related software manifests itself in exploiting the networking proximity of the posting terminal to its connected, temporarily or permanently, devices such as cameras, printers, monitors etc. and the provisioning of “time approximated” information about the existence in the possession of a given individual (for example running the posting or search terminal as described in U.S. Pat. No. 5,845,265, U.S. Pat. No. 6,085,176, U.S. Pat. No. 6,202,051, U.S. Pat. No. 6,266,651) of certain electronic items. This provides the capability of injection into the Personal Inventory or Consignment Node Databases information about them as potential objects for sale/auction/rental etc.

Prior art does not leverage the inherent connectivity/networking capability of electronic items and treats non-electronic collectible goods with no electronic presence/networking capability the same way as those that do posses any type of networking heartbeat. This omission requires human creation of consignment database records via a manual use of the posting terminal for the electronic items manually thus vastly limiting the plurality of electronic goods present in the consignment nodes databases to those that were manually selected and entered via the use of human interaction driven software. The population of the personal inventory or consignment node databases by means of humans driven input software increases the risk of either intended or unintended incorporation of incorrect or misleading information about those items into consignment node databases as well as introduces a huge number of formats in which people describe the same item. For example the prior art of doing this would list the same SONY VAIO laptop in a consignment node database as a record that contains a description of the laptop done by several different people—some of which might fail to mention what RAM memory speed it is—be it DDR PC2100 or DDRPC3200 or type of graphic chipset. Prior art treats electronic items just as regular collectibles such as pens, non electronic toys, baseball cards etc. and allows their presence to be manifested in those databases only after their largely manual/typewriting insertion into a consignment node database by the human user via a different incarnations of entirely human driven graphical user interfaces. Prior art software accessed via or running at the posting terminal such as a PC accessing an auction web site effectively acts as an authoring tool that relies on its human user to depict the characteristics of the electronic items (maybe even the exact same terminal used for this) and their conditions and those are exposed to the ones that elect to bid on the item on an honor basis, the accuracy of which can be only approximated by reviewing the user's prior auction/sale reputation as implemented by many auction sites. Current invention claims the automation of the injection of the data and guards its accuracy as being automatically gleaned by scanning the said hardware and software installed in operation in the networking proximity of the posting terminal. In other words my SONY laptop will know how to submit itself today for sale/auction/bidding/rental in solicitation of an offer if I consider this as even a remote option in the future.

### UTILITY AND USEFULNESS OF THE AIMS OF THE INVENTION

To establish an automated means for the vast increase in the number, accuracy and standardization of the format of consignment node-like, personal inventory node-like entries for electronic items by the automatic harvesting of information about electronic items in the networking proximity of posting terminals, including the internal constituents of the said terminals by using all available types of protocols furnishing direct or indirect, explicit or implicit, device discovery capabilities and detection of such device capabilities, manufacturer information such as brand, model, amount of memory, chipsets installed, amount of disk space, installed software, monitors attached, peripheral devices such as USB cameras with their corresponding model numbers, DVDs that were inserted (in the past 24 hours for example) etc.

To establish novel and unexpected means for the provisioning of personal inventory or global consignment node database entries that can be subject of induced sales or auctions which is sales or auctions that can result from offers being made on those items that would have never occurred were it not that the disclosure of the existence of such item was made automatically by injection of info about it into the consignment node or personal information node database. This can include rental queries, purchase queries etc. The owners of the item had not been actively seeking the sale or auctioning of it by actively creating a manual entry in a consignment node database (using software for the manual creation of database records via the posting terminal as described in the aforementioned patent granted U.S. Pat. No. 6,266,651 to Thomas G. Woolston ) were it not that an initial bid purchase offer has been made thus triggering an induced sale or rental consideration by legal owners. Prior art leaves out a large number of items connected to the network at the mercy of humans who quite often just do not have the time to create and author a web page and inject information about the item's auction-ability/sale-ability/rent-ability. The current invention would allow the presence of the items to be manifested in the consignment node or personal inventory databases in an automatic way and often with a one-click permission, rendering human authoring of the description page an obsolete act. This invention additionally provides ground for unusual and unique, not encountered in prior art methods and processes for the location and search of tangible electronic assets that can become the targets of a sale, auction or even short-term rental. The capability might provide users with the ability to form queries like: “Find me any person that has Mavica CDC500 in Stanford 94305 zip code that is willing to rent it for 2 days while I am there with my parents.” thus introducing amazing new business models on a global scale and providing search mechanisms well beyond existing ones implemented by Google, eBay and others.

To provide novel means to increase standardization of information about new, used or collectible electronic items within the networked proximity of the posting terminals as well as avoid fraud in the depiction of the technical characteristics of those said electronic items and their technical condition and capabilities.

To provide novel means to increase the accuracy of the information contained in the in the consignment node databases about electronic items, reducing the likelihood of fraudulent entries and avoiding population with entries about electronic items that are not in at least fundamentally electronically working condition providing the capability of automatic self-injection of information depicting it into the consignment node database(s).

To provide the means for novel, unexpected extremely convenient, automatic, one-click-permission way of population of personal inventory or global consignment node databases with entries depicting the posting terminal itself as well as all devices in its general networking proximity as potentially auctionable/saleable/rentable items off a given consignment node. This novelty should be opposed to the traditional method of manual operation of the posting terminal that is forcing substantial human input into forms that need to be filled in order to describe the item information about which is to be entered into the consignment node database.

To provide an alternative, novel, unexpected and dramatically more efficient method of the entering postings into the consignment node databases then the ones disclosed in a U.S. Pat. No. 6,266,651 to Woolston.

To provide novel means for the establishment and harvesting of automatic market price averaging weights for a given electronic item's value and its juxtaposing it with manufacturer's retail or wholesale price for the new item at the factory outlet. This approach would facilitate fluidity and real time procurement of current value of a given, say camera SONY CD350, based on their number on the market, percentages of them being actively for sale, inactively for sale (being among population of humans such that are not seeking new owner for them fully intentionally). Such a mechanism would provide an extremely valuable tool for the purposes of natural price shaping/price molding by the markets and envisioning as well as projection or market trends based on number of items in existence.

To provide novel means for automatic posting of information into personal inventory or consignment node databases about items that have no RFID (Radio Frequency Identification), Auto Identification capability(s) built-in that requires the use of expensive RFID or Auto ID sensors and identification circuits affixed to those items. The method avoids expensive RFIDs for electronic items as general transient RFID equivalency can be inferred by associating items with their network adapters serial numbers especially for home use and home based/originating trade.

To provide a novel means for electronic equipment manufacturers to provide technical statistical data about used electronic items alongside their same new item current price information that can be the benchmarked against which used electronic items of the same sort are traded and most sought after in the market and which depreciate most in value etc. This could also provide statistical information about the resale value of old items from a given vendor.

To provide novel means for the creation of so called induced market spaces of electronic items along with their novel, not encountered in prior art associated search space and search methods. The spaces originate from the dissemination of knowledge about the existence (transient or permanent) of the said electronic items in the hands/in possession of individuals accessing consignment or personal inventory nodes (via search or posting terminals/PCs)—for example (Tom has Spiderman DVD and F828 (or easy access to those along with other items)). The disseminated information can be a solid basis for search and then making unsolicited offers that can generate sales, rentals or sales opportunities given proper offer incentives. This capability more accurately mimics the way society works when humans often come up to one another and suggest or inquire about a purchase even though the person owning the item had not considered that prior to the suggestion.

To provide taxonomic order into the information about items that can be actively or passively listed, taxonomy that comports with the containment hierarchies and that promotes potential parting out of listed items.

### DETAILED DEPICTION OF THE PREFERRED EMBODIMENTS

In this preferred embodiment, many alternatives of which can be implemented by anyone skilled in the art, internet WWW browsers such as Internet Explorer or similar act as the software running on posting or search terminals being laptops, PCs, cell phones or PDAs. A consignment node can either be implemented on a centralized server or as a peer to peer massively distributed network of consignment nodes exposing a centralized consignment node illusion to the seller posting and buyer search terminals that are running www browsers. Alternatively there might be a social networked profiles web site that a user has an account on with his/her profile that can host a Personal Inventory database capabilities.

The user goes to either of those using either the WWW Browser (or an equivalent standalone application). In the current novel approach a one-click permission for a special plug-in, preferably implemented as an ActiveX/OCX component, to get downloaded into the WWW browser of the user is obtained. The Consignment Node seller or buyer or the Personal Profile holder (if a social networking Personal Inventory Node Database rather than a Consignment Node are being accessed) is considered the user. An example of such a method and process of software execution is described by U.S. Pat. No. 5,838,906. Once the permission has been granted the plug-in scans the networking vicinity of the posting/search terminal in order to detect the hardware and software capabilities of that posting or search terminal and gleans, implicitly or explicitly, information about existing hardware that constitutes the terminal as well as detectable items in the networking proximity of that said posting or search terminal. The detecting activity may occur in a periodic or callback fashion to always synch with the devices and software reality surrounding the terminals and can be configured depending on the collection of protocols forming the networking proximity. Prior art does not leverage such a non-obvious capability and relies on users explicitly typing in information about any devices a user wants to auction or sell into different types of consignment nodes. The current methods allow undecided users to decide if they might for example consider selling an item given some offer at some future point or if they might consider providing a short term rental for example of their F828 camera for a tourist flying in from New York in exchange for say 50 dollars and a DVD movie with Spiderman for them to watch during the time. Of course the software detecting the devices, DVDs and possibly installed software (ATI Mach Drivers) that can also hint about existing devices (ATI Mach) would work to a large extent being guided by a database of rules instrumental in the discovery and inference of knowledge about items in the hands of users. As a simple example for a SONY F828 or CD500 camera's this would be the scanning of the USB network. Such results could include a comment that SONY F828 was connected in 2 hours ago or is connected now and hence can be inferred it is easily accessible to the given user. The software could also detect ATI Mach video card driver in use all the time and the card itself thus informing that the device is there all the time. Of course for the laptops it might very often be sensible to assume that they are not part-able for sale. There could also be a rule that could detect a Goldstar Internet fridge in the vicinity that could render the item as a saleable device. Fry electronics and stores like this might also consider connecting their laptop computers to the network and thus providing more exposure for their salability/marketability since some user at some search station might issue a search request: “Find all User Profiles such that the user is in the possession of a SONY VAIO laptop in zip code 95131”. This invention would provide added exposure to items that are actively working rather than those that are stacked in boxes or in garages. Stores might want to consider plugging in more of their devices this way but the real strength of the invention is such that all of a sudden millions of users on the internet, many of which have a personal social networking profile would become potential sellers, auctioneers, renters of electronically accessible/detectable items such as laptops, cameras, DVDs, PCs, MP3Players or even cars such as Acura TL that interoperates with BlueTooth and hence is network detectable and can be advertised as being in the possession of a given individual.

The automated software obtains information about a given posting terminal, its display capabilities, memory installed, its type (DDR/SDRAM), processor type and revision, devices connected to USB 1.1/USB 2.0/X.X buses using readily available in the freeware/shareware and commercial domain software libraries. Posting/Search terminal is itself a rich source of items that can be listed. This includes graphic cards installed, monitor type, memory type, processor type etc. as well as detailed technical data such as their corresponding manufacturers, memory bank types, processor type with manufacturer and clock speed etc. Additionally, information about connected printers and their types, connected cameras and their types as well as other devices in the networking proximity can be detected. For example a SONY Mavica CD 350 when connected to a PC posting terminal via USB port can be detected by such software—its vendor type being SONY can be detected as Vendor ID 054c SONY Corp and Product ID specific to this camera being a SONY product.

Devices being the Posting/Search Terminals (for example SONY Laptop) provide a very efficient and automated way of creating a personal inventory database information that can also additionally be immediately injected into a consignment node and associated with the particular login of a given user that initiated the interaction with a node. Such records inserted into the global or personal consignment/inventory node databases might be marked as active, whereby the user is actively seeking bids/offers or inactive whereby it only manifests presence of a given device in the possession of a given posting/search terminal operator. Of course the amount of information in the case of inactive may have to be sometimes regarded as an approximation of existing state. For example the plug-in software might detect the presence of a camera CD350, the moment that the camera gets removed from the USB port the consignment node entry might be marked to reflect the fact that the given user did have access to this camera at a point in time. Searches for the item might reflect the state approximation still providing valuable not-encountered in prior art search method and process that is so much more dynamic than the static search methods and processes searching static web pages or advertisements on the internet. A bid/purchase offer placed by someone may in fact entice the user to get the camera to make the sale and thus this arrangement can generate business in an “induced market”. In such situation a different levels of policies can be applied whereby users expose to the global or personal consignment/inventory node only part of the information automatically detected and a fraction of the number of items that they own to offer different levels of privacy. However the prospects of a large number of induced offers generated might be so high that it could be irresistible to leave as much as one has in the consignment database as it might be that the offers could make one reconsider their former willingness to retain an item.

Probably the best example of use of such implicit or explicit information might be the case of an Averatec 3150P notebook with an attached SONY Digital Camera CD350, Creative Labs Mp3 USB Nomad MuVo and a Canon 850 color printer with a Canon CanoScan LIDE 20 scanner in its networked proximity connected via USB plus a Blue Tooth networking card that can interact with the 2004 Acura TL cell phone system. The user of the laptop visits the consignment node or social networking site for the purpose of searching for a highly sought for collectible item without networking capability (such as an old Nissan 1993 300ZX convertible) or maybe searching for ANY person that has 300zx item for sale or rental in a given ZIP code. The user goes to the consignment node or social networking web site. The document downloaded from the consignment node web site accessed via the www browser offers automatic installation of a browser plug-in similar to the one used by powerleap.com at http://www.powerleap.com/consumer/upgradefinder.htm The ActiveX component however offers significantly extended functionality even compared to such as the one available in MiTeC System Information Component (a.k.a. MSystemInfo) Copyright #1997-2003 by Michal Mutl Aubrechtove 3102, 106 00 Praha 10, Czech republic <mitec@atlas.cz>http://www.mitec.cz/. The information gleaned includes the detailed info on the laptop (memory, processor etc. )plus the knowledge of the existence of SONY Digital Camera CD350, Creative Labs Mp3 USB Nomad MuVo, Canon Lide 20 scanner, and Canon i850 printer as well as Acura TL. Information procured by USB bus scanning allows to detect Vendor and Product IDs. Those can be juxtaposed with a table that for example for maker SONY lists Product IDs that the Sony devices report on the USB bus. (Vendor ID and Product IDs reported on the USB bus can be found at http://www.linux-usb.org/usb.ids)

Once the model number has been established additional technical characteristics can be downloaded from SONY and Canon web sites and then can be encapsulated in the XML format and all that is then injected into the personal or global consignment node database (or both). Additionally the posting terminal, which is the Averatec laptop, (being also a search terminal as each one may function as a posting one in this embodiment) can also be at a later point in time carried into a Blue Tooth enabled Acura TL from 2004. This allows the downloaded automatic software, thanks to a simple rules available on the consignment or personal inventory node server, to detect that Acura TL is indeed in the networking proximity of the terminal user as only Acuras manifest their presence on the BlueTooth network due to a particular vendor BlueTooth adapter connection in place. As a result the consignment node may fetch additional information about the car from some web site, and create an XML description that can be active or inactive in the consignment node database. Of course while using the MiTeC System Information Component libraries information about computer components can be rich and profuse (from vendor type being Averatec, Product ID being a particular Averatec model up to processor type, drive capacity and size and type of memory etc., scanning USB devices for example renders Vendors IDS and Product IDs that can be supplemented by obtaining generic information from vendor web sites) the information about cars given lack of ubiquitously present or open standards can be implicitly inferred at this point. This way a user searching for old non-network-aware 300ZX (or if this was social networking database) can also easily and almost obliviously (subject to her/his privacy choices) inject today's generation electronic items into the Consignment or Personal Inventory Node. Someone else may use their browser to go to the Consignment Node to search for an Averatec 3150P or SONY CD350 or they may go to a the Social Networking web site and search for a user that has in his/her personal profile a Personal Inventory Database that contains SONY CD350 and is in their zip code, then he/she can make an inquiry: “Hey can I borrow it while I am there for 2 days?”. As far as the car is concerned the owner might want to add more info. As far as electronic devices are concerned—hardly any more info is needed. This type of novel approach can in fact provide circumstantial indication that a given vehicle is indeed in the proximity of a given individual thus increasing the accuracy of purposefulness of bidding on it or making a solicited or unsolicited offer like: “Hey I know you have Acura TL . . . Do you want to sell it? or maybe I can rent it from you while I am there as the rental places do not have those Acuras. I have full insurance I will give you the 8 DVDs you see in my Personal Consignment Node Profile”. Assuming the terminal operators do not restrict the exposure of information about the hardware/items in their proximity they can become the recipients of unsolicited offers on the items this way participating and being part of induced markets for electronically accessible goods within their networking proximity. The current invention additionally claims an auxiliary database of rules used in the inference and guessing of the existence about physical items. For example, assuming the SONY VAIO computer does have an old Toshiba PDR2 camera attached to it that does not support USB detection that would provide vendor ID and Product ID pinpointing what exact camera a user has, the downloaded software might detect its presence by detecting the software and drivers that the user had installed on the SONY VAIO for the use of the Toshiba camera. This way it can suggest to the user that he or she publishes the camera in the personal inventory or global consignment node database.

Most interesting improvement offered by the current invention is the extent to which it would improve/distribute the price comparing versus price comparing prior art web sites that are also run a form of a (Global) Consignment Node database and the SEARCH space that has typically (in sites like Google for example) been across whatever html documents and newsgroups exist on the internet and have been created by humans by their manual creation. For example price comparing web sites in the prior art rely on manually submitted information about electronic items by different vendors. For example such web sites include NexTag.com, Froogle.com, MySimon.com, PriceGrabber.com, PriceScan.com. Search for Item camera SONY Mavica CD350 lists a number of merchants that offer a given item for sale. The items can be listed by price. Users are then able to contact each of the merchants directly. The information presented is not real time and had been often collected as a result of a manually pre-arranged advertising agreement. The vendor companies advertising their products on such web sites do it by almost manually (the software tools to do that are manually driven) listing the items (a call to the given vendor might quite often result in the vendor not having the items). The present invention would foster that vendors plug the items for sale into a posting terminal at least for a moment. The posting terminal would detect the specific unique instance of the CD350, describe its characteristics by looking them up on SONY web site and list automatically THIS PARTICULAR ITEM INSTANCE. At the same time Peter having his own seldom used SONY CD350 who often searches for AMD processor laptops would go to the web site and his camera might be also listed priced competitively to the vendor that professionally sells the said camera. This way the price comparison and search for electronic items would be significantly more exciting, accurate and in depth by spanning ordinary people's possessions and not only those exposed by vendors actively advertising items. All of people part of a large networking web site would become sellers/buyers/renters/lenders and prices would very likely go down significantly and this might also provide ground for unique ad-hoc swap arrangements.

Prototype Software offering the said capabilities has been designed and built and uses readily available components downloadable and executable within the Internet Explorer such as those used by MITEC System information libraries and leverages a social network of user profiles each of which is also hosting a virtual Personal Consignment Node database. This inventor calls the entire invention space Personal Inventory Networks.

The other novel improvement provided by the present invention also lies in Personal Consignment Node Databases Renting/Borrowing/Lending items ability. When Personal Consignment Node databases are populated this way users in a social networking web site may find a person who owns an Averatec 3150 laptop and a SONY CD350 Digital camera that is attached to it. As a result users may interact leading to a person-to-person rental of the said items. This can create interesting person-to-person, peer to peer swapping, renting or sell/auction/loan/lease arrangements and business models that the inventor is researching as part of p2pmarkets.com.

### IMPLEMENTATION OF THE INVENTION BY p2pMarkets.com's eCommerce SELF-AWARE, SELF-LISTING ELECTRONIC DEVICES

The current implementations of the invention with their variations allow almost every wired or wireless electronic device (a router, switch, laptop, MP3 player, printer or even the Acura TL/Lexus LS430 BlueTooth cars—all these are in fact eDevices/eAsset/eItems since they can be electronically discovered in the electronic vicinity of a user) to automatically inject into a consignment node their detailed technical description on their own for e-commerce purposes with the click of a single button (labeled for example: “SELL ME!”) with no need for the typical manual human authoring of consignment node listings by their owners like it is the case in prior art (Woolston, eBay.com, Froogle.com etc.). The capabilities and benefits provided by the invention for eDevices/eItems/eAssets are similar or even offer far more than those offered if the device had been equipped with (an expensive often) RFID tag. The reason is that the current invention allows for Active RFID-like home originating automatic listing technology for electronic devices without RFID readers and tags. Not only does it allow a device to identify itself (like RFID) and potentially others (if they cannot on their own yet be discovered: for example an MP3 player) but it also instills the intelligence to list/publish/inject a detailed device description of the devices into consignment node databases.

If the device manufacturer furnished the implementation of the invention inside (maybe in a chip of the device or software that it runs), the device may have a web accessible user interface tab with a button (router device typically runs a WWW server inside that allows configuration) or even a physical button such that can used to publish/inject/list its depiction for e-commerce into a consignment node under the email address of its owner. If the device manufacturer did not provide it, the invention's implementation can operate off some laptop onto which it was downloaded and still provide the automatic listing/publishing/injecting (into a consignment node) for the device. The software downloaded onto the laptop shall provide a button and procure/glean detailed technical descriptions for the said injection/listing/publishing e-commerce purpose for the devices around it, including itself if needed and when the user requests it.

The request (that can be initiated with the press of a button etc) triggers the listing of one or more of the devices in a consignment node for e-commerce purposes. Such a sample automatically generated detailed consignment node listing is shown in the pictures for Hewlett Packard Presario 2100. The said laptop device is surrounded by a number of other devices (a number of printers in this case shown in the listing in figure attached) and itself is a collection of devices that are also described. Typically for e-commerce purposes the laptops constituents are only a descriptive characteristic and cannot be the target of an offer from other people. The information is automatically injected into consignment node databases as a reaction to user's request that occurred after the user traversed via screens that asked it for their email address, zip code and area code and after the user chose to click the button with their email address (in this case button labeled tmojsa@yahoo.com that is the equivalent of “SELL!” or “Advertise for Sale” button). No manual authoring of a listing to be injected/published/listed into the consignment node database is required. In the particular user interface as shown on the attached figures the user publishes all their assets in the electronic vicinity of their laptop computer in their home, of course a tiny variation allows selective choice of eDevices/eItems/eAssets to be published and deselection of the ones the user does not wish to expose to the consignment node. In this case the invention implementation is downloaded onto the laptop, the implementation generates the listing/depiction (it is possible that a factory pre-prepared listing be ready for injection in a device) and the laptop also acts as a proxy for all the devices it detects that most likely did not get equipped with the inventions implementation by their manufacturers yet can themselves be detected.

If equipped by their manufacturers each device might of course be running its own user interface that provides the capabilities—it could use a simple database of rules (can be a flat file with factory hard coded values) listing device parameters that are to be published into a consignment node to depict it when the user presses the button for example. The button could be in one of the tabs in the configuration of the device (for example if the device was a network device that allows configuring its many different parameters via a web browser this could be one additional option). The device could also dynamically re-discover its own model and characteristics (plus those of some other devices around it) based on a more sophisticated database of inference rules (than just a flat file description of its own technical parameters such as own model etc. that is the simplest form of a database of inference rules) and then inject those into consignment node when the owner/user presses a button. If the device does contain the implementation of the inventions it can self-list itself in a consignment node and possibly even other items around it depending on how comprehensive the implementation of the invention embedded in the device is. It is typically easiest to have some of the most comprehensive implementations downloaded onto the laptops since laptops being multi-purpose devices themselves can download a plug-in and do not require placing the software in a chipset or firmware for example. The user can click the button on the device user interface (if the device provides the inventions implementation and detects/(or infers about) at least itself) or on the laptop that provides the inventions implementation (downloaded for example from the web as a plug in) as shown in figures. The device self-lists by injecting its technical information/depiction and describes itself (or in the case of a laptop it also list the information about other eDevice/eItems/eAssets “around it” that it acts as a proxy for) into a consignment node(s). At the very most all that the user should do is provide an email address where they want to receive offers on it and how much they want to be paid for the eDevice/eAsset/eItem(s) selected. Unlike in traditional consignment nodes (such as eBay.com etc.) there is no need for manual human authoring of device depictions thanks to the inventions.

An example of the automated method of procurement of information about the tradeable eDevices/eItems/eAssets is shown in the figures attached. A user opens a web browser on their laptop computer and software implementing the claimed inventions gets automatically downloaded (in some cases the software might be factory preinstalled), detects and discovers the eAssets/eItems/eDevices in the laptop's networked vicinity at the home of the user, using a number of protocols and consulting a number of database of rules. Once the detection occurs the user has the option to select which of the eDevice/eItems/eAssets found are available for sale and presses a “SELL ME!” (or “Advertise me for sale”) button for each of the detected eDevice/eItems/eAssets in a list. In the case of the implementation seen on the figures attached the user is pressing a button with their email address (button labeled tmojsa@yahoo.com being the equivalent of “SELL ME!” (or “Advertise me for sale”)). This way their eAssets/eItems/eDevices get listed under this email address in the consignment node database. The user with this email is perceived to have such assets at their disposal that might be trade-able and is allowed to set the price on them or accept system derived price suggestion.

Another example: if a TV set or a set-top-box provided the implementation of the inventions it could be capable of listing (publishing/injecting into a consignment node) only itself (in the case of most limited implementation its inference rules database can be a flat file read that simply describes what model TV it is) plus maybe (in a more sophisticated implementation that requires elaborate discovery and database rules) other types of eAssets/eDevice/eItems around it. If the TV set did not provide an implementation of the invention at all, even in the simplest form, a laptop in the vicinity may be able to detect it (if the TV set can be detected using some electronic protocol and most new TV Media centers are 802.11 enabled), this way the laptop can act as a consignment node automatic listing proxy (surrogate or representative) for it. Once published into any type of consignment node the eDevices/eItems/eAssets are locate-able by p2pMarkets.com search engine. p2pMarkets.com is a consignment node e-commerce market that implements Personal Inventory Node concept over a Social Networking site that finds the eDevices/eAsset/eItems that people list with such one button click automatic listing technology based on this invention in local zip/area codes/local markets. An example of such a search engine is shown in figures and also presents the results of a search for any eAsset/eItem/eDevice called Hewlett-Packard in phone area code 650. The figures included show listings of contact information for the owners of the automatically publishable (and published) for sale eAsset/eDevice/eItems such as Hewlett-Packard device(s). This way the inventions enable automatic publishing and amassing of information about trade-able, reachable or potentially available for sale eDevices/eItems/eAssets creating maybe one day the very largest virtual electronic store/repository populated by users each with one click of a button.

The software implementation of the invention can be embedded in chipsets (in the TV or printer) or dynamically downloaded into a laptop/PC/any device that can get upgraded via the network. The invention allows identifying and listing with user permission and amazing precision and accuracy all the electronic assets in human possession with just one click of a button be it on the device itself or if the device does not have it (and cannot download the implementation of the inventions like a laptop can) on some other device that acts as a proxy for it. For example in the figures the Hewlett-Packard laptop computer allows the injection of a listing for an automatically discovered by it two Brother printers and the laptop is acting as a proxy for both of them since they do not have an embedded implementation of the invention and cannot also download an implementation of it at this time. The inventions provide for the ultimate e-commerce listing and search engine for all the eDevices/eAsset/eItems in existence and the new ones to come in the home. People using the search engine leveraging benefits of the invention may find the devices others are bored with (or not bored with just yet but they still list preemptively) and they may offer others a swapping/barter/trade-up/trade-down opportunity or just make such an amazing deal on those that one will become an induced seller. Clicking on links of the found devices can also perform regular web search on those keywords this way providing additional information on the technical characteristics of eDevices/eAssets/eItems on the world wide web (articles, reviews etc).

The consignment nodes can also be canvassed by device manufacturers. The manufacturers could buy back the device advertised this easily (the TV owned by non-sophisticated end user who knows nothing about consignment nodes yet can click the button with his email (or a “SELL!”) button and thus advertise his device for sale). The device manufacturers would provide such a user with a new one while he/she or the manufacturer itself would resell the one the user had had remotely on location without requiring the shipping and refurbishing to the manufacturer. The latter would thus bring to electronic items markets same business models that fuel well known “Lexus pre-owned certified”-like automotive programs yet virtual. The certification is simple—if a device automatically lists using the inventions (TV) or some other device detects it for listing (laptop detecting TV and allowing it to be listed) then the device (TV) most likely works OK—one does not have to just believe 100% the person owning it right now like it is with manually authored traditional consignment node listings such as those on eBay.com etc. The eAsset/eItem/eDevice sale can be thus brokered between users remotely. The users can do this on their own or with the assistance of a manufacturer that resells old equipment and sells new to a person.

The invention provides a measurement of probability as to the electronic condition of the assets too. The greatest benefit of the invention, however, are Active RFID like capabilities without the special RFID tags and readers being required for the promotion of automatic home originating trade and e-commerce leveraging automatic listing/publishing/injection into consignment nodes with no tedious manual authoring of consignment node descriptions/web pages about those said trade-able eAssets/eDevices/eItems.

1. I hereby claim the unique, novel, unexpected and not encountered in prior art method and process of environmental electronic automatic procurement of information suitable for insertion into consignment node or personal inventory node database(s) describing the existence of diverse vendor and model type electronic devices, in the possession of an individual in the proximity of his/her posting/search/access terminal, by explicit or implicit, direct or indirect detection of the said devices using arbitrary networking or connectivity protocols or inference/guessing rules.

2. Method and process recited in claim 1 wherein it serves as a method of exposing on the internet network information about personal inventories of electronically accessible items that are in the possession of individual users.

3. Method and process recited in claim 1 wherein it automates and facilitates the population of consignment nodes that can be later used for finding and searching for trade-able electronic items in the possession of individual users.

4. Method and process recited in claim 1 wherein guessing of the existence of electronic items in the possession of individuals takes place by detecting installed software artifacts used by those electronic items or distinguishable components of theirs in the vicinity of posting/search/access terminals, such that the information gleaned can be used in the population of consignment node or personal inventory databases.

5. Method and process recited in claim 1 wherein it is implemented as downloadable or preinstalled software coupled to downloadable or preinstalled inference/properties rules database running on the device that enables one click listing/injection/publication of e-commerce listing of the eDevice/eAsset/eItem into a personal inventory or consignment node with no need for manual description of the eDevice/eAsset/eItem by humans.

6. Method and process recited in claim 1 wherein the downloadable or preinstalled software uses minimal user input and performs discovery as a result of unexpected use of different arbitrary communication protocols in order to collect a list of items alongside their vendor and model type within the proximity of the posting terminal either by explicit or implicit communication with them using arbitrary networking or connectivity protocol thus automatically rendering information such that it is suitable after some minor modification/supplementing for insertion into a consignment node database.

7. Method and process recited in claim 1 wherein it is aided by auxiliary database of rules used in the inference, guessing or discovery about the existence of physical items or their physical electronic and technical characteristics that are essential parts of the publication of the device's listing in a consignment node.

8. Method and process recited in claim 1 wherein it allows for automated and vastly expedited, compared to manual consignment node listing data injection, injection of listing data into consignment nodes thus allowing for the seeking of physical electronically accessible goods in the possession of networking vicinity of individuals.

9. Method and process recited in claim 1 wherein the depicted automation of the injection of the data into different types of consignment nodes occurs by scanning the said hardware and software installed in operation in the networking and electronic proximity of the posting/search terminal.

10. Method and process recited in claim 1 wherein it allows for an almost one-click way of population of personal inventory or global consignment node databases with entries depicting the posting terminal itself as well as all devices in its general networking proximity as potentially auctionable/saleable/rentable/tradeable items off a given consignment node.

11. Method and process recited in claim 1 wherein it is exploiting the networking proximity of the posting terminal to its connected, temporarily or permanently, devices such as cameras, printers, monitors etc. and wherein it is provisioning “time approximated information about the existence in the possession of a given individual (for example running the posting or search terminal as described in U.S. Pat. No. 5,845,265, U.S. Pat. No. 6,085,176, U.S. Pat. No. 6,202,051, U.S. Pat. No. 6,266,651) of certain electronic items as well as wherein it is furnishing the capability of automatic injection of thus automatically gleaned data into the Personal Inventory or Consignment Node Databases.

12. I claim the provisioning in any electronic device of a user interface (physical or downloadable or as a standalone application) with the associated underlying capability to generate or obtain the device's and possibly other device's technical description for e-commerce (suitable for injection in consignment or personal inventory nodes) such that the user interface enables automatic one click listing/publishing/injection of the electronic device's (and potentially also of other electronic devices', detected in its vicinity) e-commerce relevant characteristics into a number of consignment nodes, where the device(s) listing/depiction information automatically injected/published/listed this way becomes associated with the email address or a unique identifier or a profile of the owner of the said device(s) where their owner wishes to receive offers related to them without the need to manually create or author web pages with such a listing.

13. I claim the unusual, unexpected and non-obvious use of posting terminals that minimizes or even obliterates the need for human and manual gathering and authoring of the information injectable into the various types of consignment node-like/personal inventory node-like databases and that provides for enormous proliferation of very accurate entries about tangible eAssets/eItems/eDevices that the terminals and their surrounding eAssets/eItems/eDevices represent.
